(19) United States
(12) Patent Application Publication
(10) Pub. No.: US 2018/0330233 A1
(43) Pub. Date: Nov. 15, 2018

(54) MACHINE LEARNING BASED SCATTER CORRECTION

(71) Applicant: General Electric Company, Schenectady, NY (US)

(72) Inventors: Xue Rui, Clifton Park, NY (US); Hua Qian, Clifton Park, NY (US); Hao Lai, Niskayuna, NY (US); Bruno Kristiaan Bernard De Man, Clifton Park, NY (US); John Eric Tkaczyk, Delanson, NY (US)

(21) Appl. No.: 15/593,157

(22) Filed: May 11, 2017

(51) Int. Cl. G06N 3/08; G06F 17/50; G06F 19/00; G06N 3/04

(52) U.S. Cl. CPC G06N 3/08; G06F 17/5009; G06T 5/00; G06N 3/04; G06F 2217/16; G06F 19/321

(57) ABSTRACT

The present approach relates to the use of machine-learning in convolution kernel design for scatter correction. In one aspect, a neural network is trained to replace or improve the convolution kernel used for scatter correction. The training data set may be generated probabilistically so that actual measurements are not employed.

### TECHNICAL FIELD

The subject matter disclosed herein relates to scatter correction in imaging contexts, and in particular to the use of machine learning techniques to facilitate scatter artifact correction or reduction.

### BACKGROUND

Non-invasive imaging technologies allow images of the internal structures or features of a patient/object to be obtained without performing an invasive procedure on the patient/object. In particular, such non-invasive imaging technologies rely on various physical principles (such as the differential transmission of X-rays through a target volume, the reflection of acoustic waves within the volume, the paramagnetic properties of different tissues and materials within the volume, the breakdown of targeted radionuclides within the body, and so forth) to acquire data and to construct images or otherwise represent the observed internal features of the patient/object.

Certain such imaging techniques, including Positrons Emission Tomography (PET), X-ray computed tomography (CT) and Cone-beam CT (CBCT), may be subject to scatter-type artifacts, in which the linear path of a particle that is detected as part of the imaging process is diverted during its transmission from some origination point to the detector apparatus. This non-linear travel is referred to as “scatter” and may be due to a particle interacting with one or more other particles or structures on its path through the imaged volume. As a consequence of such scatter events, the scattered particle may result in a detection event at a location that does not correspond to the expected linear path, which may lead to image artifacts since such linear paths are presumed in the reconstruction processes. Such scatter-related artifacts can impact image quality and diagnostic value of the resulting image.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible embodiments. Indeed, the invention may encompass a variety of forms that may be similar to or different from the embodiments set forth below.

In one embodiment, a method is provided. In accordance with this method, measured data is acquired from an imaging scanner. The measured data or a single scatter profile derived from the measured data is provided to a trained neural network as an input. A scatter profile or one or more convolution kernel parameters is received as an output from the trained neural network. A scatter corrected image is generated using the measured data and a final scatter estimate derived from one of the scatter profile or a convolution kernel parameterized with the one or more convolution kernel parameters.

In a further embodiment, an image processing system is provided. In accordance with this embodiment, the image processing system includes a processing component configured to execute one or more stored processor-executable routines and a memory storing the one or more executable-routines. The one or more executable routines, when executed by the processing component, cause acts to be performed comprising: accessing measured data acquired by an imaging scanner; providing the measured data or a single scatter profile derived from the measured data to a trained neural network as an input; receiving as an output from the trained neural network a scatter profile or one or more convolution kernel parameters; and generating a scatter corrected image using the measured data and a final scatter derived from one of the scatter profile or a convolution kernel parameterized with the one or more convolution kernel parameters.

For computed tomography (CT), cone-beam CT (CBCT) systems, and/or other X-ray based systems, the convolution kernel based deconvolution method is a popular scatter correction algorithm that estimates the scatter profile directly from the projection data by convolving with spatially invariant kernel models. This method does not require additional hardware or scans, and the computational cost is typically low, especially compared to high-cost Monte-Carlo-based scatter simulation. However, the accuracy of the deconvolution method depends on the kernel design and the associated parameters. These parameters are usually determined empirically or based on a complicated optimization process and they may vary from one scan settings to another. For example, any change in the tube spectrum or in the pre-patient beam collimation will affect these parameters. Therefore, it is a challenge to design a kernel and determine the kernel parameters to accurately estimate the scatter profile.

In an additional embodiment, a method for training a neural network is provided. In accordance with this method, a set of training data is probabilistically generated. A neural network is trained using the set of training data to output a scatter profile, a multiple scatter profile, a scatter-corrected dataset, or one or more parameters of a scatter convolution kernel

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an example of an artificial neural network for training a deep learning model, in accordance with aspects of the present disclosure;

FIG. 2 is a block diagram depicting components of a computed tomography (CT) imaging system, in accordance with aspects of the present disclosure;

FIG. 3 is a diagrammatical representation of an embodiment of a positron emission tomography (PET) imaging system in accordance with aspects of the present disclosure;

FIG. 4 depicts a process flow for training a neural network using non-measured training data, in accordance with aspects of the present disclosure;

FIG. 5 depicts a process flow of a scatter-correction process, in accordance with aspects of the present disclosure;

FIG. 6 depicts a simplified flow for generating a multiple scatter profile, in accordance with aspects of the present disclosure;

FIG. 7 depicts a simplified flow for generating convolution kernel parameters, in accordance with aspects of the present disclosure;

FIG. 8 depicts a simplified flow for generating a total scatter profile, in accordance with aspects of the present disclosure

FIG. 9; depicts another simplified flow for generating a multiple scatter profile, in accordance with aspects of the present disclosure; and

FIG. 10 depicts a simplified flow for generating convolution kernel parameters or a multiple scatter profile using additional parameters, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

While aspects of the following discussion are provided in the context of medical imaging, it should be appreciated that the present techniques are not limited to such medical contexts. Indeed, the provision of examples and explanations in such a medical context is only to facilitate explanation by providing instances of real-world implementations and applications. However, the present approaches may also be utilized in other contexts, such as tomographic image reconstruction for industrial computed tomography (CT) used in non-destructive inspection of manufactured parts or goods (i.e., quality control or quality review applications), and/or the non-invasive inspection of packages, boxes, luggage, and so forth (i.e., security or screening applications). In general, the present approaches may be useful in any imaging or screening context or image processing field where a set or type of acquired data subject to scattering artifacts undergoes a reconstruction process to generate an image or volume.

Further, though positron emission tomography (PET) and X-ray computed tomography (CT) examples are provided herein, it should be understood that the present approach may be used in other imaging modality contexts where tomographic reconstruction processes that may benefit from scatter correction are employed. For instance, the presently described approach may also be employed on data acquired by other types of tomographic scanners including, but not limited to, X-ray radiography, Cone-Beam CT, tomosynthesis, and/or single photon emission computed tomography (SPECT).

By way of introduction, several imaging modalities, such as X-ray CT (e.g., multi-slice CT) and X-ray C-arm systems (e.g., cone-beam CT), measure projections of the object or patient being scanned where the projections, depending on the technique, correspond to Radon transform data, fan-beam transform data, cone-beam transform data, or non-uniform Fourier transforms. In other contexts, the scan data may be emission type data (e.g., PET or SPECT data) in which a radiopharmaceutical administered to a patient breaks down, resulting in particle emissions, which may be detected and localized to obtain diagnostically useful information. Tomographic reconstruction algorithms are employed in conjunction with these imaging modalities to generate useful volumetric representations or images from raw measurements.

In practice, such tomographic reconstruction approaches assume that a detection event corresponds to a detected particle or photon that has traveled in a straight line-of-flight, such as from an emission location or radiation source. However, some number of detected events arise from non-linear trajectories, where the detected particle or photon deviates from a straight path through the imaged volume due to one or multiple interactions with other structures or particles within the imaged volume.

Such scattering is a source of artifacts and the correction of scattering is of benefit in obtaining high quality images for diagnosis or obtaining quantitative measurement metrics from the images. In conventional approaches, convolution-based scatter correction algorithms are used for CT, CBCT, PET and X-ray radiography modalities to address scatter artifacts. These algorithms require fine tuning of a convolution kernel, and typically require measurement data for the kernel parameter tuning. This process is complicated and designing an accurate kernel can be difficult.

The present approach addresses these issues by using a machine-learning based (in one implementation a deep learning based) convolution kernel design. In one aspect, a neural network is trained to replace the convolution kernel used for scatter correction. The training data set may be generated from Monte Carlo simulations, so that actual measurements are not employed. By way of example, one approach would be to train the parameters of a convolution kernel using machine-learning. For example, in PET, five parameters are used for the convolution kernel design and some or all of these parameters may be trained using machine learning. Similarly, in CT, CBCT, or other suitable imaging context, some number of parameters may be specified in designing a convolution kernel and some or all of these parameters may be trained using machine learning as discussed herein. An alternative approach with respect to these imaging modalities would be to replace the convolution-kernel-based scatter estimation with a trained neural network (e.g., a convolution network).

With the preceding introductory comments in mind, some embodiments of the approaches described herein utilize neural networks, or other machine learning approaches, as part of the scatter correction process used in conjunction with generation of tomographic images, such as CT, CBCT, PET, SPECT, and C-arm images. As may be appreciated, trained neural networks as discussed herein can be trained for each type of system. In some embodiments, such trained networks can use the measurements generated by a respective system with feedback loops as inputs to the trained neural network, which makes the network self-learning in implementation.

Neural networks as discussed herein may encompass deep neural networks, fully connected networks, convolutional neural networks (CNNs), perceptrons, auto encoders, recurrent networks, wavelet filter banks, or other neural network architectures. These techniques are generally referred to herein as machine learning. In certain implementations discussed herein, one possible implementation of machine learning may be deep learning techniques, and such deep learning terminology may also be used specifically in reference to the use of deep neural networks, which is a neural network having a plurality of layers.

As discussed herein, deep learning techniques (which may also be known as deep machine learning, hierarchical learning, or deep structured learning) are a branch of machine learning techniques that employ mathematical representations of data and artificial neural network for learning. By way of example, deep learning approaches may be characterized by their use of one or more algorithms to extract or model high level abstractions of a type of data of interest. This may be accomplished using one or more processing layers, with each layer typically corresponding to a different level of abstraction or a different stage or phase of a process or event and, therefore potentially employing or utilizing different aspects of the initial data or outputs of a preceding layer (i.e., a hierarchy or cascade of layers) as the target of the processes or algorithms of a given layer. In an image processing or reconstruction context, this may be characterized as different layers corresponding to the different feature levels or resolution in the data. In general, the processing from one representation space to the next-level representation space can be considered as one ‘stage’ of the process. Each stage of the reconstruction can be performed by separate neural networks or by different parts of one larger neural network.

As discussed herein, as part of the initial training of deep learning processes to solve a particular problem, such as derivation of convolution kernel parameters, training data sets may be employed that have known initial values (e.g., input images, projection data, emission data, and so forth) and known or desired values for a final output (e.g., reconstructed tomographic reconstructions, such as cross-sectional images or volumetric representations) of the deep learning process. The training of a single stage may have known input values corresponding to one representation space and known output values corresponding to a next-level representation space. In this manner, the deep learning algorithms may process (either in a supervised or guided manner or in an unsupervised or unguided manner) the known or training data sets until the mathematical relationships between the initial data and desired output(s) are discerned and/or the mathematical relationships between the inputs and outputs of each layer are discerned and characterized. Similarly, separate validation data sets may be employed in which both the initial and desired target values are known, but only the initial values are supplied to the trained deep learning algorithms, with the outputs then being compared to the outputs of the deep learning algorithm to validate the prior training and/or to prevent over-training.

By way of example, in one contemplated implementation, supervised training of the neural network utilizes training data generated from Monte Carlo (or other probabilistic) simulations in lieu of measurement data to represent scatter events. In view of such modeled training data, raw and scatter profiles are thereby available for training the neural network in question, either to generate tuned parameters for a convolution kernel or to perform the scatter estimation functionality directly.

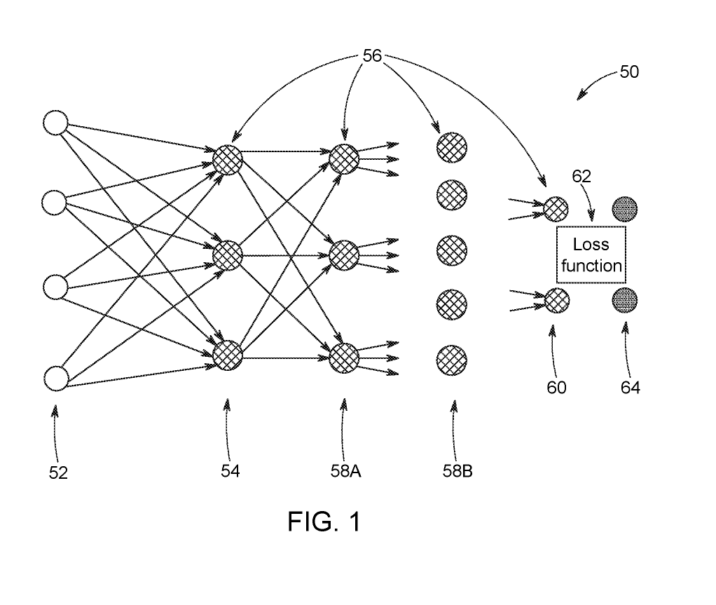

With the preceding in mind, FIG. 1 schematically depicts an example of an artificial neural network 50 that may be trained as a deep learning model as discussed herein. In this example, the network 50 is multi-layered, with a training input 52 and multiple layers including an input layer 54, hidden layers 58A, 58B, and so forth, and an output layer 60 and the training target 64 present in the network 50. Each layer, in this example, is composed of a plurality of “neurons” or nodes 56. The number of neurons 56 may be constant between layers or, as depicted, may vary from layer to layer. Neurons 56 at each layer generate respective outputs that serve as inputs to the neurons 56 of the next hierarchical layer. In practice, a weighted sum of the inputs with an added bias is computed to “excite” or “activate” each respective neuron of the layers according to an activation function, such as rectified linear unit (ReLU), sigmoid function, hyperbolic tangent function, or otherwise specified or programmed. The outputs of the final layer constitute the network output 60 (e.g., one or more convolution kernel parameters, a convolution kernel, or a multiple scatter profile) which, in conjunction with the training target 64, are used to compute some loss or error function 62, which will be backpropagated to guide the network training.

The loss or error function 62 measures the difference between the network output (e.g., a convolution kernel or kernel parameter) and the training target. In certain implementations, the loss function may be a mean squared error (MSE) of the voxel-level values or partial-line-integral values and/or may account for differences involving other image features, such as image gradients or other image statistics. Alternatively, the loss function 62 could be defined by other metrics associated with the particular task in question, such as a softmax function.

In a training example, the neural network 50 may first be constrained to be linear (i.e., by removing all non-linear units) to ensure a good initialization of the network parameters. The neural network 50 may also be pre-trained stage-by-stage using computer simulated input-target data sets, as discussed in greater detail below. After pre-training, the neural network 50 may be trained as a whole and further incorporate non-linear units.

To facilitate explanation of the present tomographic reconstruction approach using deep learning techniques, the present disclosure discusses these approaches in the context of a PET or CT system. However, it should be understood that the following discussion may also be applicable to other image modalities and systems including, but not limited to, PET, CT, CBCT, PET-CT, PET-MR, C-arm, SPECT, multi-spectral CT, as well as to non-medical contexts or any context where tomographic reconstruction is employed to reconstruct an image.

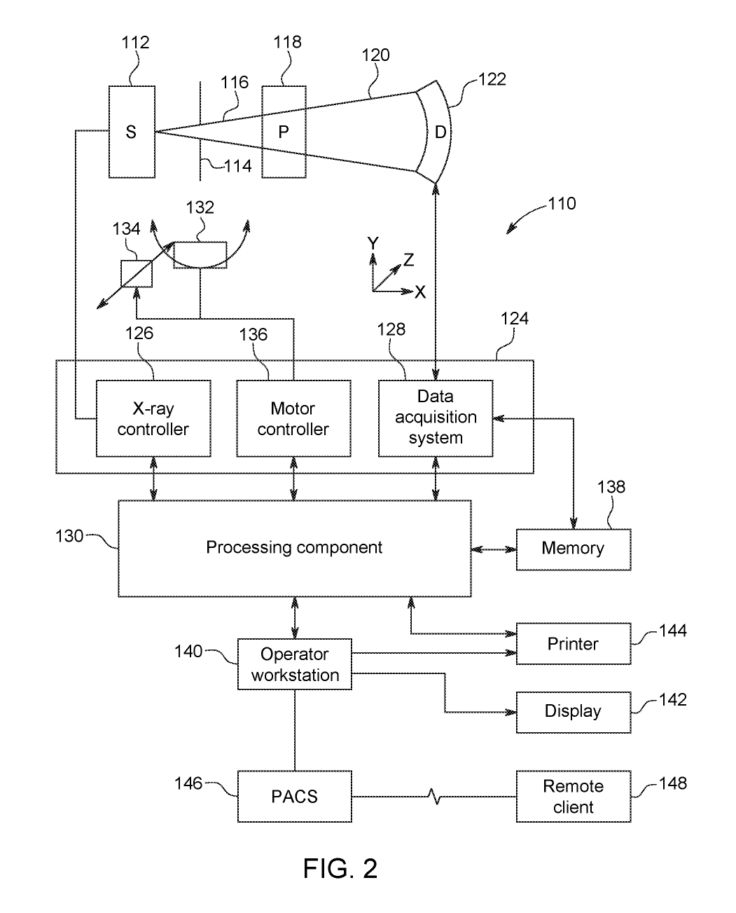

With this in mind, an example of a CT imaging system 110 (i.e., a CT scanner) is depicted in FIG. 2. In the depicted example, the imaging system 110 is designed to acquire scan data (e.g., X-ray attenuation data) at a variety of views around a patient (or other subject or object of interest) and suitable for performing image reconstruction using tomographic reconstruction techniques. In the embodiment illustrated in FIG. 2, imaging system 110 includes a source of X-ray radiation 112 positioned adjacent to a collimator 114. The X-ray source 112 may be an X-ray tube, a distributed X-ray source (such as a solid-state or thermionic X-ray source) or any other source of X-ray radiation suitable for the acquisition of medical or other images.

In the depicted example, the collimator 114 shapes or limits a beam of X-rays 116 that passes into a region in which a patient/object 118, is positioned. In the depicted example, the X-rays 116 are collimated to be a cone-shaped beam, i.e., a cone-beam, that passes through the imaged volume. A portion of the X-ray radiation 120 passes through or around the patient/object 118 (or other subject of interest) and impacts a detector array, represented generally at reference numeral 122. Detector elements of the array produce electrical signals that represent the intensity of the incident X-rays 120. These signals are acquired and processed to reconstruct images of the features within the patient/object 118.

Source 112 is controlled by a system controller 124, which furnishes both power, and control signals for CT examination sequences, including acquisition of two-dimensional localizer or scout images used to identify anatomy of interest within the patient/object for subsequent scan protocols. In the depicted embodiment, the system controller 124 controls the source 112 via an X-ray controller 126 which may be a component of the system controller 124. In such an embodiment, the X-ray controller 126 may be configured to provide power and timing signals to the X-ray source 112.

Moreover, the detector 122 is coupled to the system controller 124, which controls acquisition of the signals generated in the detector 122. In the depicted embodiment, the system controller 124 acquires the signals generated by the detector using a data acquisition system 128. The data acquisition system 128 receives data collected by readout electronics of the detector 122. The data acquisition system 128 may receive sampled analog signals from the detector 122 and convert the data to digital signals for subsequent processing by a processor 130 discussed below. Alternatively, in other embodiments the digital-to-analog conversion may be performed by circuitry provided on the detector 122 itself. The system controller 124 may also execute various signal processing and filtration functions with regard to the acquired image signals, such as for initial adjustment of dynamic ranges, interleaving of digital image data, and so forth.

In the embodiment illustrated in FIG. 2, system controller 124 is coupled to a rotational subsystem 132 and a linear positioning subsystem 134. The rotational subsystem 132 enables the X-ray source 112, collimator 114 and the detector 122 to be rotated one or multiple turns around the patient/object 118, such as rotated primarily in an x,y-plane about the patient. It should be noted that the rotational subsystem 132 might include a gantry or C-arm upon which the respective X-ray emission and detection components are disposed. Thus, in such an embodiment, the system controller 124 may be utilized to operate the gantry or C-arm.

The linear positioning subsystem 134 may enable the patient/object 118, or more specifically a table supporting the patient, to be displaced within the bore of the CT system 110, such as in the z-direction relative to rotation of the gantry. Thus, the table may be linearly moved (in a continuous or step-wise fashion) within the gantry to generate images of particular areas of the patient 118. In the depicted embodiment, the system controller 124 controls the movement of the rotational subsystem 132 and/or the linear positioning subsystem 134 via a motor controller 136.

In general, system controller 124 commands operation of the imaging system 110 (such as via the operation of the source 112, detector 122, and positioning systems described above) to execute examination protocols and to process acquired data. For example, the system controller 124, via the systems and controllers noted above, may rotate a gantry supporting the source 112 and detector 122 about a subject of interest so that X-ray attenuation data may be obtained at one or more views relative to the subject. In the present context, system controller 124 may also include signal processing circuitry, associated memory circuitry for storing programs and routines executed by the computer (such as routines for performing tomographic reconstruction techniques described herein), as well as configuration parameters, image data, and so forth.

In the depicted embodiment, the image signals acquired and processed by the system controller 124 are provided to a processing component 130 for reconstruction of scatter-corrected images in accordance with the presently disclosed algorithms. The processing component 130 may be one or more general or application-specific microprocessors. The data collected by the data acquisition system 128 may be transmitted to the processing component 130 directly or after storage in a memory 138. Any type of memory suitable for storing data might be utilized by such an exemplary system 110. For example, the memory 138 may include one or more optical, magnetic, and/or solid state memory storage structures. Moreover, the memory 138 may be located at the acquisition system site and/or may include remote storage devices for storing data, processing parameters, and/or routines for tomographic image reconstruction, as described below.

The processing component 130 may be configured to receive commands and scanning parameters from an operator via an operator workstation 140, typically equipped with a keyboard and/or other input devices. An operator may control the system 110 via the operator workstation 140. Thus, the operator may observe the reconstructed images and/or otherwise operate the system 110 using the operator workstation 140. For example, a display 142 coupled to the operator workstation 140 may be utilized to observe the reconstructed images and to control imaging. Additionally, the images may also be printed by a printer 144 which may be coupled to the operator workstation 140.

Further, the processing component 130 and operator workstation 140 may be coupled to other output devices, which may include standard or special purpose computer monitors and associated processing circuitry. One or more operator workstations 140 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, virtual private networks, and so forth.

It should be further noted that the operator workstation 140 may also be coupled to a picture archiving and communications system (PACS) 146. PACS 146 may in turn be coupled to a remote client 148, radiology department information system (RIS), hospital information system (HIS) or to an internal or external network, so that others at different locations may gain access to the raw or processed image data.

While the preceding discussion has treated the various exemplary components of the imaging system 110 separately, these various components may be provided within a common platform or in interconnected platforms. For example, the processing component 130, memory 138, and operator workstation 140 may be provided collectively as a general or special purpose computer or workstation configured to operate in accordance with the aspects of the present disclosure. In such embodiments, the general or special purpose computer may be provided as a separate component with respect to the data acquisition components of the system 110 or may be provided in a common platform with such components. Likewise, the system controller 124 may be provided as part of such a computer or workstation or as part of a separate system dedicated to image acquisition.

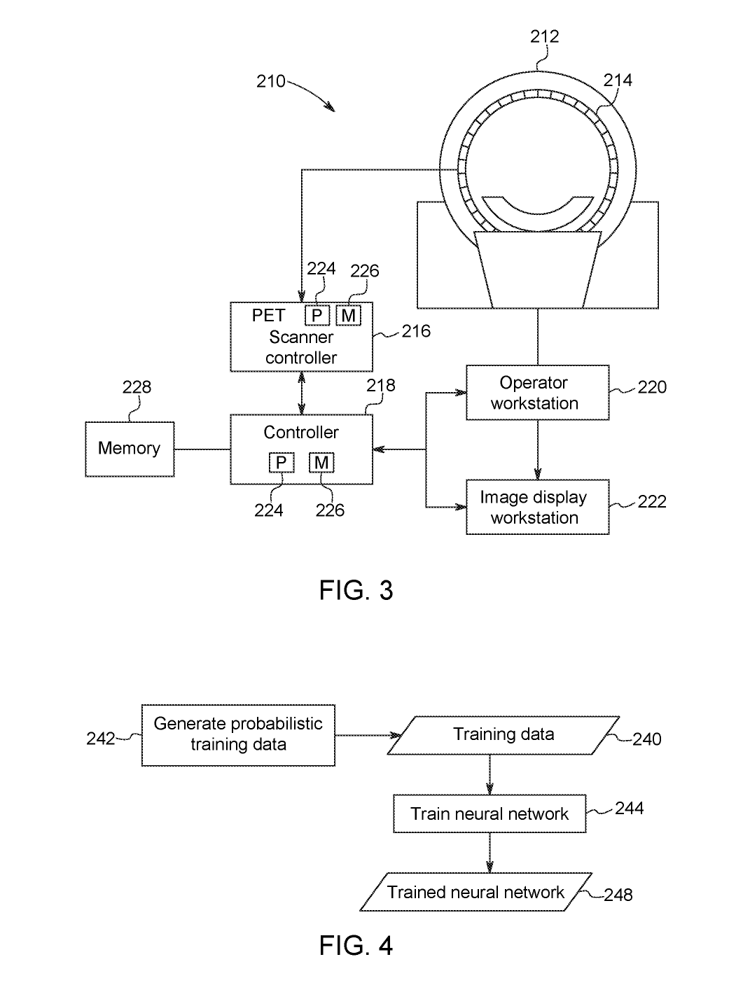

Similarly, turning to FIG. 3, a simplified view of a PET or SPECT system 210 operating in accordance with certain aspects of the present disclosure. The depicted PET or SPECT system 210 includes a detector 212 (or detector array). The detector 212 of the PET or SPECT system 210 typically includes a number of detector modules or detector assemblies (generally designated by reference numeral 214) arranged in one or more rings, as depicted in FIG. 3, each detector assembly 214 includes multiple detector units (e.g., 3 to 5 detector units or more). The depicted PET or SPECT system 210 also includes a PET scanner controller 216, a controller 218, an operator workstation 220, and an image display workstation 222 (e.g., for displaying an image). In certain embodiments, the PET scanner controller 216, controller 218, operator workstation 220, and image display workstation 222 may be combined into a single unit or device or fewer units or devices.

The PET scanner controller 216, which is coupled to the detector 212, may be coupled to the controller 218 to enable the controller 218 to control operation of the PET scanner controller 216. Alternatively, the PET scanner controller 216 may be coupled to the operator workstation 220 which controls the operation of the PET scanner controller 216. In operation, the controller 218 and/or the workstation 220 controls the real-time operation of the PET system or SPECT system 210. One or more of the PET scanner controller 216, the controller 218, and/or the operation workstation 220 may include a processor 224 and/or memory 226. In certain embodiments, the PET or SPECT system 210 may include a separate memory 228. The detector 212, PET scanner controller 216, the controller 218, and/or the operation workstation 220 may include detector acquisition circuitry for acquiring image data from the detector 212, as well as image reconstruction and processing circuitry for image processing for generating scatter-free or scatter-reduced images as discussed herein. The circuitry may include specially programmed hardware, memory, and/or processors.

The processor 224 may include multiple microprocessors, one or more “general-purpose” microprocessors, one or more special-purpose microprocessors, and/or one or more application specific integrated circuits (ASICS), system-on-chip (SoC) device, or some other processor configuration. For example, the processor 224 may include one or more reduced instruction set (RISC) processors or complex instruction set (CISC) processors. The processor 224 may execute instructions to carry out the operation of the PET or SPECT system 210. These instructions may be encoded in programs or code stored in a tangible non-transitory computer-readable medium (e.g., an optical disc, solid state device, chip, firmware, etc.) such as the memory 226, 228. In certain embodiments, the memory 226 may be wholly or partially removable from the controller 216, 218.

By way of example, PET imaging is primarily used to measure metabolic activities that occur in tissues and organs and, in particular, to localize aberrant metabolic activity. In PET imaging, the patient is typically injected with a solution that contains a radioactive tracer. The solution is distributed and absorbed throughout the body in different degrees, depending on the tracer employed and the functioning of the organs and tissues. For instance, tumors typically process more glucose than a healthy tissue of the same type. Therefore, a glucose solution containing a radioactive tracer may be disproportionately metabolized by a tumor, allowing the tumor to be located and visualized by the radioactive emissions. In particular, the radioactive tracer emits positrons that interact with and annihilate complementary electrons to generate pairs of gamma rays. In each annihilation reaction, two gamma rays traveling in opposite directions are emitted. In a PET imaging system 210, the pair of gamma rays are detected by the detector array 212 configured to ascertain that two gamma rays detected sufficiently close in time are generated by the same annihilation reaction. Due to the nature of the annihilation reaction, the detection of such a pair of gamma rays may be used to determine the line of response along which the gamma rays traveled before impacting the detector, allowing localization of the annihilation event to that line. By detecting a number of such gamma ray pairs, and calculating the corresponding lines traveled by these pairs, the concentration of the radioactive tracer in different parts of the body may be visually depicted and a tumor, thereby, may be detected. Thus, scatter events changing the trajectory of one of the paired gamma rays may result in an image error or artifact, which may degrade the diagnostic value of an image.

With the preceding in mind, the present approach employs machine learning techniques, including but not limited to deep learning approaches, to facilitate scatter correction in images generated using systems such as the CT imaging system 110 and PET imaging system 210 discussed above, as well as other suitable imaging modalities. By way of example, deep learning is used in one implementation for convolution kernel design and/or optimization. Turning to FIG. 4, in one such example, a neural network 50 is trained (step 244) to generate a trained neural network 248 used to replace or parameterize the convolution kernel used in the scatter correction process. Training data 240 in this approach may be generated (step 242) using Monte Carlo simulations or other probabilistic techniques such that measurement data is not employed, though in other implementations actual measurement data may employed or incorporated into the training of the neural network. The present approach allows for the generation and use of substantially large and robust training sets that may be used to train the neural networks discussed herein.

By way of example, one approach would be to train the parameters of a convolution kernel as an initial step. This may be explained in the context of PET imaging, which may be complicated due to the possibility of multiple scattering events affecting a detected particle. As noted herein, however, parameters for convolution kernels associated with other imaging modalities, such as X-ray CT, CBCT, and so forth may be trained in a corresponding manner. In the context of the present example, the convolution kernel may be used to produce a multiple scatter profile from the convolution of a single scatter profile.

With respect to the present PET example, in conventional approaches, there are five parameters used for the convolution kernel design in the context of PET imaging. Typically, these five parameters are tuned using measurements obtained with phantoms. More specifically, the amplitude A(r) and standard deviation σ(r) of the convolution kernels are position variant and linearly related to a Gaussian-smoothed path length δ(r):

$$\begin{matrix}1 ) & A ( r ) = {a}_{1} δ ( r ) + {a}_{0} \\ 2 ) & σ ( r ) = {β}_{1} δ ( r ) + {β}_{0}\end{matrix}$$

Thus, the five parameters to be trained are: α₀, α₁, β₀, β₁, and σ₁.

Some or all of these parameters may be trained in the present approach using deep learning techniques (i.e., a trained neural network 248) or other suitable machine-learning approaches. In particular, in contrast to generating a limited number of measurements using a known phantom, the neural network 248 used to generate or refine the parameters may be trained using substantially more data points as the training data 240 is generated using Monte Carlo or other statistical simulations, thus allowing for a larger and more robust training set.

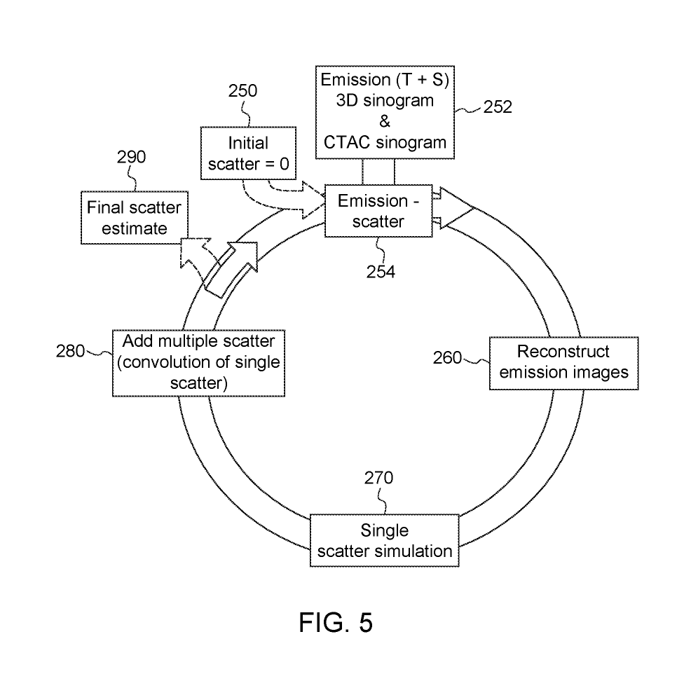

With the preceding in mind, FIG. 5 depicts a PET scatter correction algorithm flow in a conventional scheme. As depicted, the process is iterated or looped so that an initial scatter estimate is used in the first iteration, but the results of the scatter estimation are used to seed subsequent steps or some set number of iterations or until a threshold criterion is met. In this example, initial scatter estimate 250 is set to zero. The emission 3D sinogram and CT-based attenuation correction sinogram are also input (step 252) to derive an estimate 254 of the measured emission minus the current scatter estimate. The estimate 254 may be used to reconstruct (block 260) emission images that may be used to estimate or simulate the probabilistic results of a single scatter event, yielding a single scatter simulation or profile 270.

As noted above, PET data (as well as date for other imaging modalities) may actually be subject to multiple scatter events for a given particle. Thus, after the single scatter profile is obtained, a convolution approach is used to calculate the multiple scatter profile by generating a convolution (step 280) of the single scatter profile. As may be appreciated, it is at this step that the convolution kernel (or trained convolution network) discussed herein is employed.

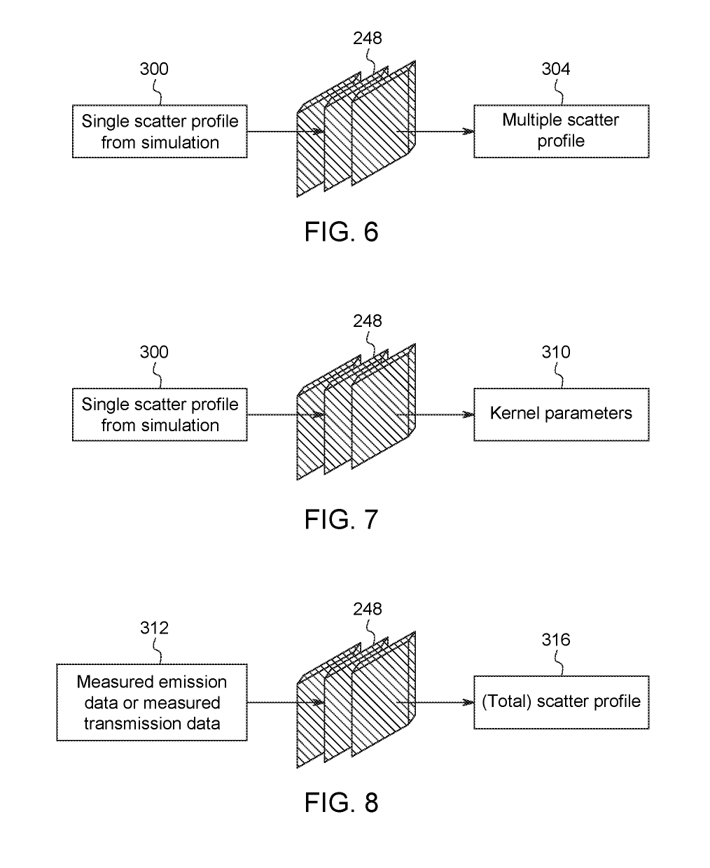

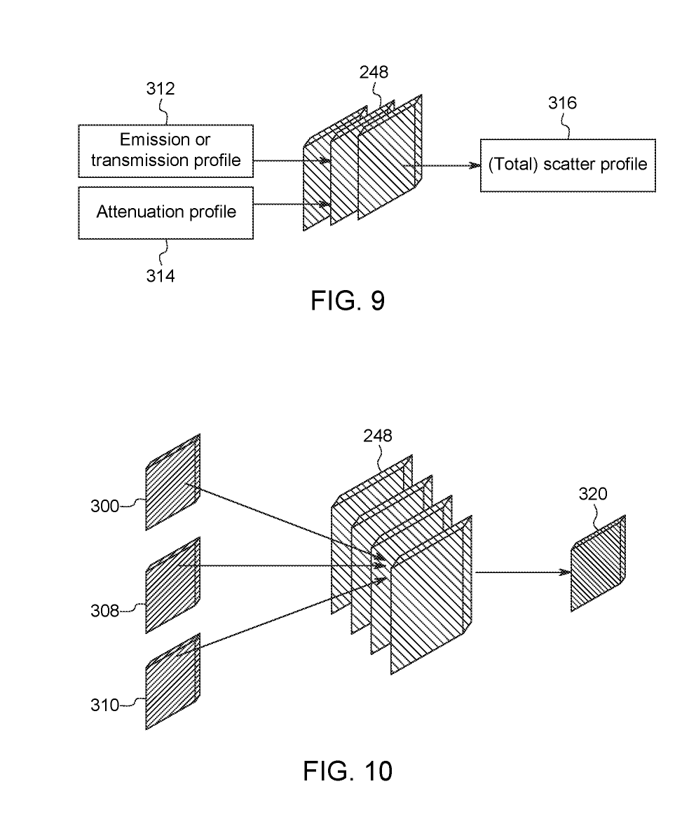

Thus, as may be appreciated, the present approaches improve or replace the performance of the convolution at step 280, either by improving parameterization of a convolution kernel employed at that step or replacing the convolution kernel with a trained convolution neural network. By way of example, and turning to FIG. 6, a trained neural network 248 is depicted which receives a single scatter profile 300 from probabilistic simulation as an input and, as an output, generates a multiple scatter profile 304. Alternatively, as noted herein, instead of replacing the convolution kernel with a trained neural network (i.e., a convolution network) the trained network 248 may instead generate as an output, as shown in FIG. 7, one or more of the convolution kernel parameters 310 and a convolution kernel may be employed with these parameters. Alternatively, as depicted in FIG. 8, the trained network 248 may use as inputs one or more of the CT transmission data or the PET emission data 312 and output a scatter profile, such as total scatter profile 316. Similarly, as depicted in FIG. 9, the trained network 248 may use as inputs one or more of the CT transmission data or the PET emission data 312 as well as corresponding attenuation data 314 and output a scatter profile, such as total scatter profile 316.

A further example, is illustrated in FIG. 10. Per this example, the trained network 248 may be further generalized by training the network 248 to accept additional information as inputs to provide a more generalized and/or more robust estimated scatter profile 320. In this example, the network 248 still receives a scatter profile 300 as an input (e.g., a single scatter based scatter profile in a PET context or a model-based scatter profile in a CT context). In addition, the neural network 248 may be trained to receive an image 308 of the patient (such as a reconstructed image, a scout image, an ATLAS image, and so forth) as an input. Similarly instead of or in addition to the image 308 other information 310 may be provided as an input relating the presence and/or location of high density material or other structures or materials relevant to scatter effects.

In this manner, the trained neural network 248 may receive as an input a single scatter either alone or with additional information and from those inputs may generate convolution kernel parameters used to tune a convolution kernel capable of generating a multiple scatter profile from the input single scatter profile. Alternatively, the output can be the multiple or total scatter profile itself.

In general, inputs to the neural network 248 may include transmission profiles, emission profiles, attenuation profiles, single scatter profiles, clinical patient information, reconstructed images, scout scans or atlas images. Outputs from the neural network 248 may include single scatter profiles, multiple scatter profiles, total scatter profiles, scatter-corrected emission profiles, scatter-corrected transmission profiles, scatter-corrected attenuation profiles, and scatter-kernel parameters. The functionality of the network as discussed herein is to estimate scattered radiation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method, comprising:
acquiring measured data from an imaging scanner;
providing the measured data or a single scatter profile derived from the measured data to a trained neural network as an input;
receiving as an output from the trained neural network a scatter profile or one or more convolution kernel parameters; and
generating a scatter corrected image using the measured data and a final scatter estimate derived from one of the scatter profile or a convolution kernel parameterized with the one or more convolution kernel parameters.

2. The method of claim 1, wherein the one or more convolution kernel parameters of the convolution kernel parameterize one or both of the amplitude or standard deviation of a convolution operation implemented using the convolution kernel.

3. The method of claim 1, comprising providing additional data or images as input to the neural network.

4. The method of claim 3, wherein the additional data comprises one or more attenuation profiles.

5. The method of claim 1, wherein the imaging scanner is a PET imaging scanner and the measured data is emission data.

6. The method of claim 1, wherein the imaging scanner is an X-ray based imaging modality and the measured data is transmission data.

7. The method of claim 6, wherein the X-ray based imaging modality is one of computed tomography or cone-beam computed tomography.

8. The method of claim 1, wherein the scatter kernel is used to generate a multiple scatter profile or total scatter profile from a single scatter profile.

9. An image processing system comprising:
a processing component configured to execute one or more stored processor-executable routines; and
a memory storing the one or more executable-routines, wherein the one or more executable routines, when executed by the processing component, cause acts to be performed comprising:
accessing measured data acquired by an imaging scanner;
providing the measured data or a single scatter profile derived from the measured data to a trained neural network as an input;
receiving as an output from the trained neural network a scatter profile or one or more convolution kernel parameters; and
generating a scatter corrected image using the measured data and a final scatter derived from one of the scatter profile or a convolution kernel parameterized with the one or more convolution kernel parameters.

10. The image processing system of claim 9, wherein the one or more convolution kernel parameters of the convolution kernel parameterize one or both of the amplitude or standard deviation of a convolution operation implemented using the convolution kernel.

11. The image processing system of claim 9, wherein the measured data comprises PET emission data.

12. The image processing system of claim 9, wherein the measured data comprises X-ray transmission data.

13. The image processing system of claim 9, wherein the scatter kernel is used to generate a multiple scatter profile or total scatter profile from a single scatter profile

14. A method for training a neural network comprising:
probabilistically generating a set of training data; and
training a neural network using the set of training data to output a scatter profile, a multiple scatter profile, a scatter-corrected dataset, or one or more parameters of a scatter convolution kernel.

15. The method of claim 14, further comprising not using measurement data to train the neural network.

16. The method of claim 14 wherein probabilistically generating the set of training data comprises running a set of Monte Carlo simulations.

17. The method of claim 14, wherein the one or more parameters of the convolution kernel parameterize one or both of the amplitude or standard deviation of a convolution operation implemented using the convolution kernel.

18. The method of claim 14 wherein the training of the neural network is imaging modality specific.

19. The method of claim 14 wherein the imaging modality is one of a PET imaging modality or an X-ray imaging modality.

20. The method of claim 14, wherein the neural network is further trained to receive as an input an image of a patient.

21. The method of claim 14, wherein the neural network is further trained to receive as an input information relating one or both of the presence or location of attenuating material or structures.
